(19) United States
(12) Patent Application Publication
(10) Pub. No.: US 2024/0332678 A1
(43) Pub. Date: Oct. 3, 2024

(54) BATTERY CELL AND BATTERY MODULE

(71) Applicant: HONDA MOTOR CO., LTD., Tokyo (JP)

(72) Inventors: Keiichiro OKA, Saitama (JP); Takahiro TAMURA, Saitama (JP)

(21) Appl. No.: 18/586,562

(22) Filed: Feb. 26, 2024

(30) Foreign Application Priority Data
Mar. 29, 2023 (JP) 2023-053125

(51) Int. Cl. H01M 50/103; H01M 50/176; H01M 50/186

(52) U.S. Cl. CPC H01M 50/103; H01M 50/176; H01M 50/186

(57) ABSTRACT

Provided is a battery cell including an electrode laminated body configured such that a plurality of positive electrodes and a plurality of negative electrodes are laminated on each other via an electrolyte, a wrapping material that wraps the electrode laminated body, and a first frame member and a second frame member arranged between the electrode laminated body and the wrapping material on both sides of the electrode laminated body in the lamination direction thereof. The first frame member and the second frame member respectively include opposing portions that cover surfaces of the electrode laminated body which face the first frame member and the second frame member. Each of the first frame member and the second frame member includes an extending portion extending from each of the opposing portions in the lamination direction of the electrode laminated body.

This application is based on and claims the benefit of priority from Japanese Patent Application No. 2023-053125, filed on 29 Mar. 2023, the content of which is incorporated herein by reference.

### BACKGROUND OF THE INVENTION

### Field of the Invention

The present invention relates to a battery cell and a battery module.

### Related Art

In recent years, in order to be able to ensure, for more people, access to reasonable, reliable, sustainable, and advanced energy, research and development have been conducted on a battery cell contributing to an enhancement in energy efficiency.

The battery cell includes, for example, an electrode laminated body configured such that a plurality of positive electrodes and a plurality of negative electrodes are laminated on each other via an electrolyte and a wrapping member that wraps the electrode laminated body.

PCT International Publication No. WO2019/188825 describes a battery cell including a battery laminated body configured such that at least a positive electrode layer, an electrolyte layer, and a negative electrode layer are laminated on each other in this order and an exterior body that houses the battery laminated body. In this configuration, the exterior body includes a folded portion formed by folding a single film and a joint portion at which opposing end portions of the film are joined to each other. Moreover, the battery laminated body is housed in a support having substantially a C-shaped section in the lamination direction of the battery laminated body.
Patent Document 1: PCT International Publication No. WO2019/188825

### SUMMARY OF THE INVENTION

However, there is risk of the battery cell of PCT International Publication No. WO2019/188825 being damaged because a space between opposing portions of the support having substantially the C-shaped section in the lamination direction changes when the battery laminated body expands and contracts accompanying charge and discharge of the battery laminated body. As a result, the reliability of the battery cell is degraded.

An object of the present invention is to provide a battery cell with an improved reliability.
(1) A battery cell including an electrode laminated body configured such that a plurality of positive electrodes and a plurality of negative electrodes are laminated on each other via an electrolyte, a wrapping material that wraps the electrode laminated body, and a first frame member and a second frame member arranged between the electrode laminated body and the wrapping material on both sides of the electrode laminated body in the lamination direction thereof, in which the first frame member and the second frame member respectively include opposing portions that cover surfaces of the electrode laminated body which face the first frame member and the second frame member, wherein the opposing portions of the first frame member and the second frame member are opposed to each other, and each of the first frame member and the second frame member includes an extending portion extending from each of the opposing portions in the lamination direction of the electrode laminated body.
(2) The battery cell according to (1), which further includes a positive electrode tab lead and a negative electrode tab lead protruding from the wrapping material, in which the extending portion extends along the surface of the wrapping material on the side from which neither the positive electrode tab lead nor the negative electrode tab lead protrudes.
(3) The battery cell according to (2), in which the extending portion extends along part of the surface of the wrapping material on the side from which the positive electrode tab lead or the negative electrode tab lead protrudes.
(4) The battery cell according to (2) or (3), in which the first frame member and the second frame member each have a greater length in the direction of protrusion of the positive electrode tab lead and the negative electrode tab lead than that of the electrode laminated body.
(5) The battery cell according to any one of (2) to (4), in which the wrapping material includes a sealed portion at an outer peripheral portion on the side from which the positive electrode tab lead or the negative electrode tab lead protrudes, the sealed portion formed at the outer peripheral portion on the side from which the positive electrode tab lead protrudes is formed in such a manner that the wrapping material is sealed at the periphery of the positive electrode tab lead in the lamination direction of the electrode laminated body and a remaining portion of the wrapping material is subsequently sealed in the direction perpendicular to the lamination direction of the electrode laminated body and the direction of protrusion of the positive electrode tab lead, and the sealed portion formed at the outer peripheral portion on the side from which the negative electrode tab lead protrudes is formed in such a manner that the wrapping material is sealed at the periphery of the negative electrode tab lead in the lamination direction of the electrode laminated body and a remaining portion of the wrapping material is subsequently sealed in the direction perpendicular to the lamination direction of the electrode laminated body and the direction of protrusion of the negative electrode tab lead.
(6) The battery cell according to any one of (1) to (5), in which the first frame member and the second frame member each include extending portions opposed to each other.
(7) The battery cell according to (6), in which the extending portions opposed to each other of each of the first frame member and the second frame member are arranged with a predetermined space therebetween.
(8) The battery cell according to any one of (1) to (7), in which the wrapping material is a laminate film.
(9) A battery module includes a plurality of the battery cell according to any one of (1) to (8) laminated therein.

According to the present invention, a battery cell can be provided with the improved reliability.

### BRIEF DESCRIPTION OF THE DRAWINGS

FIG. 1 is a sectional view showing one example of a battery module of the present embodiment;

FIG. 2 is a perspective view showing a battery cell of FIG. 1;

FIG. 3 is a sectional view taken along line A-A in FIG. 2;

FIG. 4 is a sectional view taken along line B-B in FIG. 2; and

FIG. 5 is a perspective view showing a modification of the battery cell of FIG. 2.

### DETAILED DESCRIPTION OF THE INVENTION

Hereinafter, an embodiment of the present invention will be described with reference to the drawings.

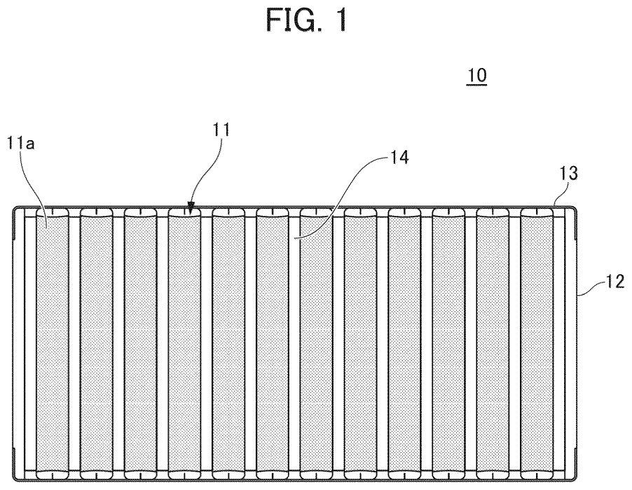

FIG. 1 shows one example of a battery module of the present embodiment.

A battery module 10 includes a battery cell laminated body 11 including a plurality of battery cells 11a laminated on each other, end plates 12 which are a pair of plate-shaped members provided at both ends of the battery cell laminated body 11 in the lamination direction thereof, and binding bars 13 which are restraining members that restrain the pair of end plates 12 and the battery cell laminated body 11 therebetween to each other. In the figure, the binding bars 13 are placed at two upper and lower positions. The battery module 10 is configured such that cushion members 14 are arranged in each portion between adjacent ones of the plurality of battery cells 11a and each portion between the battery cell 11a and the end plate 12.

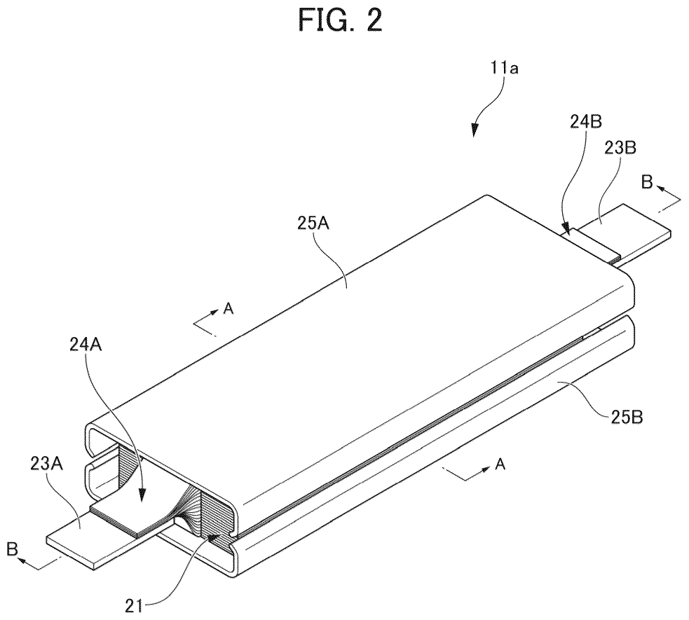

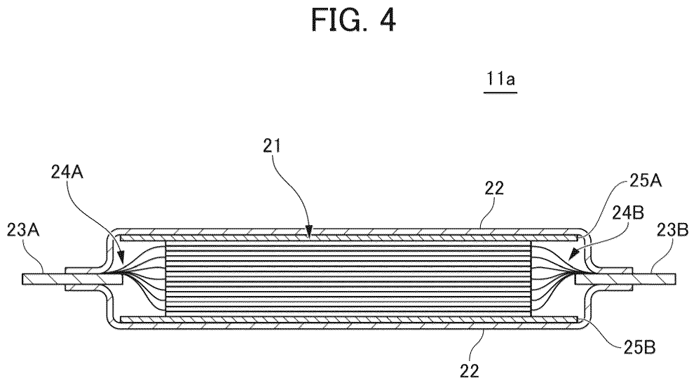

As shown in FIGS. 2 to 4, the battery cell 11a is configured such that an electrode laminated body 21 is wrapped with a laminate film 22 which is a wrapping material, and has a positive electrode tab lead 23A and a negative electrode tab lead 23B protruding in opposite directions from the laminate film 22. Note that the laminate film 22 is not shown in FIG. 2. The electrode laminated body 21 is configured such that a plurality of positive electrodes and a plurality of negative electrodes are laminated on each other via an electrolyte. Examples of the electrolyte include an electrolytic solution and a solid electrolyte, and the electrolytic solution is held in a separator. The positive electrode tab lead 23A is connected to the plurality of positive electrodes via positive electrode tabs 24A. On the other hand, the negative electrode tab lead 23B is connected to the plurality of negative electrodes via negative electrode tabs 24B.

The battery cell 11a has, between the electrode laminated body 21 and the laminate film 22, a first frame member 25A and a second frame member 25B arranged on both sides of the electrode laminated body 21 in the lamination direction thereof. The first frame member 25A and the second frame member 25B include respective opposing portions O that each cover the surface of the electrode laminated body 21 in the lamination direction thereof, and are opposed to each other. Further, each of the first frame member 25A and the second frame member 25B has extending portions R extending in the lamination direction of the electrode laminated body 21 at both end portions of the opposing portion O and opposing each other. When the first frame member 25A and the second frame member 25B are viewed in a cross section, these members are substantially C-shaped. Thus, even when the electrode laminated body 21 expands and contracts accompanying charge and discharge of the electrode laminated body 21, a space between the opposing portions O of the first frame member 25A and the second frame member 25B can be adjusted, and therefore, the reliability of the battery cell 11a improves. Moreover, even when the electrode laminated body 21 expands and contracts accompanying charge and discharge of the electrode laminated body 21, damage to the upper and lower surfaces of the electrode laminated body 21 in the lamination direction thereof is reduced.

The first frame member 25A and the second frame member 25B have a greater length in the direction of protrusion of the positive electrode tabs 24A and the negative electrode tab lead 23B than that of the electrode laminated body 21. Thus, even when the laminate film 22 contracts upon lamination, damage to the side surfaces of the electrode laminated body 21 on the sides from which the positive electrode tab lead 23A and the negative electrode tab lead 23B protrude is suppressed.

The battery module 10 is configured such that the opposing portions O are arranged on both sides of the cushion member 14 in the lamination direction of the electrode laminated body 21. With this configuration, the uniformity of the surface pressure of the cushion member 14 is improved.

Each of the first frame member 25A and the second frame member 25B has the extending portions R opposing each other. With this configuration, the heat dissipation of the battery cell 11a and thermal uniformity of the battery cell 11a are improved.

Note that the extending portions R do not necessarily extend so as to face each other and, for example, the extending portion R may extend in the lamination direction of the electrode laminated body 21 from one end portion of the opposing portion O. Alternatively, the extending portion R may extend from a position other than the end portion of the opposing portion O.

The extending portions R of the first frame member 25A and the second frame member 25B extend along the surfaces of the laminate film 22 on the sides from which neither the positive electrode tab lead 23A nor the negative electrode tab lead 23B protrudes. With this configuration, even when the laminate film 22 contracts upon lamination, damage to the side surfaces of the electrode laminated body 21 on the sides from which neither the positive electrode tab lead 23A nor the negative electrode tab lead 23B protrudes is suppressed.

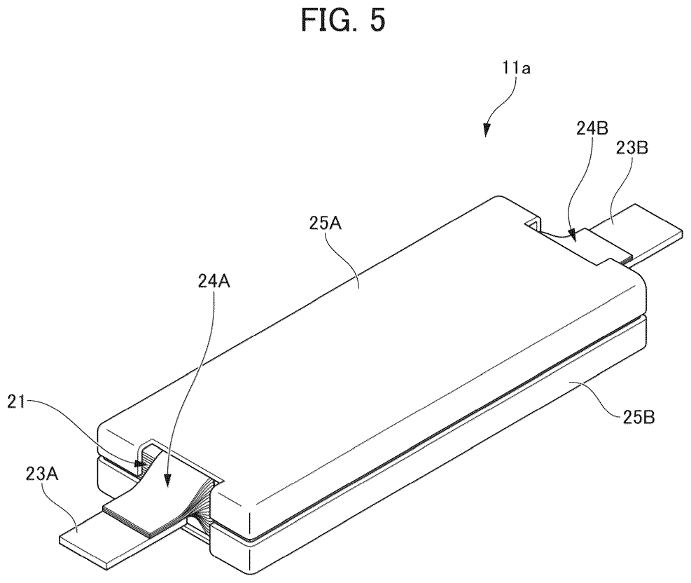

Note that the extending portions R of the first frame member 25A and the second frame member 25B may extend along part of the surfaces of the laminate film 22 on the sides from which the positive electrode tab lead 23A and the negative electrode tab lead 23B protrude (see FIG. 5). With this configuration, even when the laminate film 22 contracts upon lamination, damage to the side surfaces of the electrode laminated body 21 on the sides from which the positive electrode tab lead 23A and the negative electrode tab lead 23B protrude is suppressed.

The opposing extending portions R of each of the first frame member 25A and the second frame member 25B are arranged with a predetermined space therebetween. With this configuration, even in a case where the electrode laminated body 21 expands and contracts accompanying charge and discharge of the electrode laminated body 21, the space between the opposing portions O of the first frame member 25A and the second frame member 25B is easily adjustable.

The space between the opposing extending portions R of each of the first frame member 25A and the second frame member 25B at a SOC of 0% is not particularly limited and, for example, is 0.5 mm or more and 4 mm or less.

The material constituting the first frame member 25A and the second frame member 25B is not particularly limited as long as the material has a high stiffness and examples thereof include stainless steel and aluminum.

The Young's modulus of the first frame member 25A and the second frame member 25B is not particularly limited and, for example, is 70 GPa or more and 210 GPa or less.

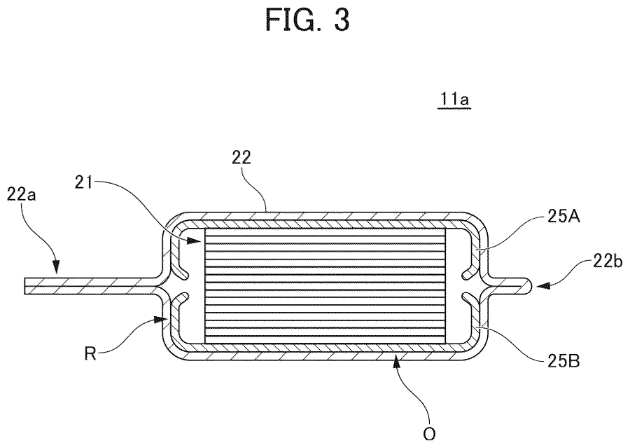

As shown in FIG. 3, the laminate film 22 includes a sealed portion 22a at an outer peripheral portion on one of the sides from which neither the positive electrode tab lead 23A nor the negative electrode tab lead 23B protrudes, and includes a folded portion 22b at an outer peripheral portion on the other side from which neither the positive electrode tab lead 23A nor the negative electrode tab lead 23B protrudes. Moreover, the laminate film 22 includes sealed portions at outer peripheral portions on the sides from which the positive electrode tab lead 23A and the negative electrode tab lead 23B protrude.

The outer peripheral portion of the laminate film 22 formed with the folded portion 22b has a shorter distance to the electrode laminated body 21 than that of the outer peripheral portion of the laminate film 22 formed with the sealed portion 22a. With this configuration, even in a case where the outer peripheral portion of the laminate film 22 formed with the sealed portion 22a is folded in consideration of the energy density of the battery module 10, damage to the electrode laminated body 21 is suppressed because the first frame member 25A and the second frame member 25B are arranged.

When the sealed portion is formed at the outer peripheral portion on the side from which the positive electrode tab lead 23A (or the negative electrode tab lead 23B) protrudes, the laminate film 22 is sealed at the periphery of the positive electrode tab lead 23A (or the negative electrode tab lead 23B) in the lamination direction (up-down direction in FIG. 3) of the electrode laminated body 21, and thereafter, the remaining portion of the laminate film 22 is sealed in a direction (right-left direction in FIG. 3) perpendicular to the lamination direction of the electrode laminated body 21 and the direction of protrusion of the positive electrode tab lead 23A (or the negative electrode tab lead 23B). With this configuration, the productivity of the battery cell 11a improves.

Note that the laminate film 22 may include sealed portions at both outer peripheral portions on the sides from which neither the positive electrode tab lead 23A nor the negative electrode tab lead 23B protrudes. Alternatively, for example, a tube-shaped laminate film may be used, and no sealed portions may be formed at both outer peripheral portions on the sides from which neither the positive electrode tab lead 23A nor the negative electrode tab lead 23B protrudes.

The cushion member 14 is not particularly limited as long as the cushion member 14 can absorb expansion and contraction of the battery cell 11a, and examples thereof include foam. The material constituting the foam is not particularly limited, and examples thereof include polyurethane, silicone resin, ethylene-propylene rubber, styrene resin, olefin resin, polyamide, and polyester.

The thickness of the foam is not particularly limited, and for example, is 1 mm or more and 2 mm or less.

The laminate film 22 is formed, for example, with a resin layer on a metal layer surface. As the metal constituting the metal layer includes, examples include aluminum. Examples of the resin constituting the resin layer include polyethylene, polyvinyl fluoride, and polyvinylidene chloride.

The battery cell 11a is not particularly limited; however, examples thereof include solid-state battery cells such as an all-solid-state lithium ion battery cell and an all-solid-state lithium metal battery cell and non-aqueous electrolyte battery cells such as a lithium metal battery cell. Among these cells, solid-state battery cells are preferred.

Hereinafter, a case where the battery cell 11a is an all-solid-state lithium metal battery cell will be described.

The all-solid-state lithium metal battery cell is configured, for example, such that a positive electrode current collector, a positive electrode compounding agent layer, a solid electrolyte layer, a lithium metal layer, and a negative electrode current collector are laminated in this order.

The positive electrode current collector is not particularly limited, but examples thereof include aluminum foil.

The positive electrode compounding agent layer contains a positive electrode active material, and may further contain a solid electrolyte, a conductivity aid, a binder, etc.

The positive electrode active material is not particularly limited as long as the positive electrode active material can store and release lithium ions; however, examples thereof include

LiCoO₂, Li(Ni_{5/10}Co_{2/10}Mn_{3/10})O₂, Li(Ni_{6/10}Co_{2/10}Mn_{2/10})O₂, Li(Ni_{8/10}Co_{1/10}Mn_{1/10})O₂, Li(Ni_{0.8}Co_{0.15}Al_{0.05})O₂, Li(Ni_{1/6}Co_{4/6}Mn_{1/6})O₂, Li(Ni_{1/3}Co_{1/3}Mn_{1/3})O₂, LiCoO₄, LiMn₂O₄, LiNiO₂, LiFePO₄, lithium sulfide, and sulfur.

The solid electrolyte constituting the solid electrolyte layer is not particularly limited as long as the solid electrolyte is a material capable of conducting lithium ions; however, examples thereof include oxide-based electrolytes and sulfide-based electrolytes.

The negative electrode current collector is not particularly limited; however, examples thereof include copper foil.

An embodiment of the present invention has been described above, but the present invention is not limited to the above-described embodiment, and the above-described embodiment may be modified as appropriate within the scope of the gist of the present invention.

### EXPLANATION OF REFERENCE NUMERALS

10 Battery Module
11 Battery Cell Laminated Body
11a Battery Cell
12 End Plate
13 Binding Bar
14 Cushion Member
21 Electrode Laminated Body
22 Laminate Film
22a Sealed Portion
22b Folded Portion
23A Positive Electrode Tab Lead
23B Negative Electrode Tab Lead
24A Positive Electrode Tab
24B Negative Electrode Tab
25A First Frame Member
25B Second Frame Member
O Opposing Portion
R Extending Portion

What is claimed is:

1. A battery cell comprising:
an electrode laminated body configured such that a plurality of positive electrodes and a plurality of negative electrodes are laminated on each other via an electrolyte;
a wrapping material that wraps the electrode laminated body; and
a first frame member and a second frame member arranged between the electrode laminated body and the wrapping material on both sides of the electrode laminated body in a lamination direction thereof,
wherein the first frame member and the second frame member respectively include opposing portions that cover surfaces of the electrode laminated body which face the first frame member and the second frame member, wherein the opposing portions of the first frame member and the second frame member are opposed to each other, and each of the first frame member and the second frame member has an extending portion extending from each of the opposing portions in the lamination direction of the electrode laminated body.

2. The battery cell according to claim 1, further comprising:
a positive electrode tab lead and a negative electrode tab lead protruding from the wrapping material,
wherein the extending portion extends along a surface of the wrapping material on a side from which neither the positive electrode tab lead nor the negative electrode tab lead protrudes.

3. The battery cell according to claim 2, wherein the extending portion extends along part of a surface of the wrapping material on a side from which the positive electrode tab lead or the negative electrode tab lead protrudes.

4. The battery cell according to claim 2, wherein the first frame member and the second frame member each have a greater length in a direction of protrusion of the positive electrode tab lead and the negative electrode tab lead than that of the electrode laminated body.

5. The battery cell according to claim 2, wherein
the wrapping material includes a sealed portion at an outer peripheral portion on a side from which the positive electrode tab lead or the negative electrode tab lead protrudes,
the sealed portion formed at the outer peripheral portion on the side from which the positive electrode tab lead protrudes is formed in such a manner that the wrapping material is sealed at a periphery of the positive electrode tab lead in the lamination direction of the electrode laminated body and a remaining portion of the wrapping material is subsequently sealed in a direction perpendicular to the lamination direction of the electrode laminated body and a direction of protrusion of the positive electrode tab lead, and
the sealed portion formed at the outer peripheral portion on the side from which the negative electrode tab lead protrudes is formed in such a manner that the wrapping material is sealed at a periphery of the negative electrode tab lead in the lamination direction of the electrode laminated body and a remaining portion of the wrapping material is subsequently sealed in a direction perpendicular to the lamination direction of the electrode laminated body and a direction of protrusion of the negative electrode tab lead.

6. The battery cell according to claim 1, wherein the first frame member and the second frame member each include extending portions opposed to each other.

7. The battery cell according to claim 6, wherein the extending portions opposed to each other of each of the first frame member and the second frame member are arranged with a predetermined space therebetween.

8. The battery cell according to claim 1, wherein the wrapping material is a laminate film.

9. A battery module comprising: a plurality of the battery cell according to claim 1 laminated therein.
